(19) United States
(12) Patent Application Publication
(10) Pub. No.: US 2003/0132409 A1
(43) Pub. Date: Jul. 17, 2003

(54) Valve arrangement for use in vacuum systems

(75) Inventor: Michael Birkelund, Middelfart (DK)

Correspondence Address: Richard R. Michaud, McCormick, Paulding & Huber LLP, 185 Asylum Street, City Place II, Hartford, CT, 06103, US

(73) Assignee: Danfoss A/S, Nordborg (DK)

(21) Appl. No.: 10/323,140

(22) Filed: Dec. 18, 2002

(30) Foreign Application Priority Data
Jan. 12, 2002 (DE) 102 00 979.1

(51) Int. Cl. F16K 31/12

(52) U.S. Cl. 251/30.04

(57) ABSTRACT

A valve arrangement for use in vacuum systems has a housing (1) with an input opening (3) and output opening (5), between which is arranged a main valve (7) with a closure member (9) biased by a first spring (11) and an auxiliary valve (15) acutable by a electromagnet (18) and having a smaller nominal width than that of the main valve (7). To simplify the valve arrangement and to be able to actuate with less energy, the closure member (9) of the main valve (7) is biased in the opening direction by a first spring (11) and the force of the first spring (11) is larger than a predetermined closing force exerted on the closure member (9) of the main valve (7) by the pressure difference between the input and output openings (3, 5) when the auxiliary valve (15) is open.

### CROSS REFERENCE TO RELATED APPLICATIONS

Applicant hereby claims foreign priority under 35 U.S.C. §119 from German Application No. 102 00 979.15 filed Jan. 12, 2002, the disclosure of which is herein incorporated by reference.

### FIELD OF THE INVENTION

The invention concerns a valve arrangement for use in vacuum systems, with a housing having a input opening and an output opening, between which is arranged a main valve with a closure member biased by a first spring and an auxiliary valve actuable by an electromagnet and having a smaller nominal width than that of the main valve.

### BACKGROUND OF THE INVENTION

In a known valve arrangement of this type, which is commercially available and through which a chamber is evacuated by a vacuum pump, the main and the auxiliary valves are arranged parallel to one another. The auxiliary valve is a magnetic valve. To begin the operation of the vacuum pump both valves are first closed. Then a short time after the starting of the vacuum pump the auxiliary valve is opened. Then the pressure in the chamber to be evacuated falls. Because of the small nominal width (for example the small through-flow cross-section or the small K,-value) of the auxiliary valve the vacuum pump is not suddenly loaded by a high mass flow or pressure impulse and accordingly is not overstressed. Sometime later the main valve is opened by an electromagnet or an air pressure controlled actuator against the force of the first spring and the chamber is further evacuated up to the desired value through the larger nominal value of the main valve.

The invention has as its object, the provision of a valve arrangement of the aforementioned kind which is of simple and compact construction and which needs little acutating energy.

### SUMMARY OF THE INVENTION

In accordance with the invention, this object is solved in that that the closure member of the main valve is biased by the first spring in the opening direction and the force of the first spring is larger than a predetermined closing force exerted on the closure member of the main valve by the pressure difference between the input and output openings when the auxiliary valve is in its open condition.

With this solution the first spring alone is sufficient for the opening of the main valve, and the first spring can be designed to be weak and small since it has to open the main valve only against a relatively low pressure difference between the input and output openings of the housing.

It is especially beneficial if the valve seat of the auxiliary valve is formed by a through-going bore in the closure member of the main valve. Thereby the main valve forms also a portion of the auxiliary valve. This results in a still more simple and more compact construction of the valve arrangement, since the need for a separate construction component for the valve seat of the auxiliary valve disappears.

Therefore the force of the first spring can be smaller than that of the second spring, against the force of which the auxiliary valve is opened by the electromagnet. After the switching off of the electromagnet the force of the second spring effects the closing of the main valve, so that the need for an actuator for the main valve disappears.

Preferably for the above it is provided that the housing has a cylindrical housing portion, in which the main valve is co-axially formed with the closure member of the main valve being coaxial and guided perpendicularly to a connection stud providing the input opening. In this case the closure member of the main valve can be formed so as to have through-going recesses at a larger circumference than that of the valve seat of the main valve. In this way it is avoided that hollow spaces remain in the housing in which during evacuation air pressure can form which impedes the opening of the main valve.

If the combined cross-sectional surface area of the recesses is larger than the nominal width of the auxiliary valve, it is assured that the total hollow space of the valve housing is evacuated similarly to the evacuation of the chamber to be evacuated and the evacuation is not impeded.

### BRIEF DESCRIPTION OF THE DRAWINGS

The invention and its further developments are described more closely by way a preferred exemplary embodiment with the aid of the accompanying drawings. The drawings schematically illustrate:

FIG. 1. An axial section through the exemplary embodiment according to the invention of a valve arrangement in closed condition for use between a vacuum pump and a chamber to be evacuated,

FIG. 2 The same axial section as in FIG. 1, but with the auxiliary valve of the valve arrangement in opened condition, and

FIG. 3. The same axial section as in FIG. 1 in the entirely opened condition of the valve arrangement.

### DETAILED DESCRIPTION OF THE PREFERRED EMBODIMENT

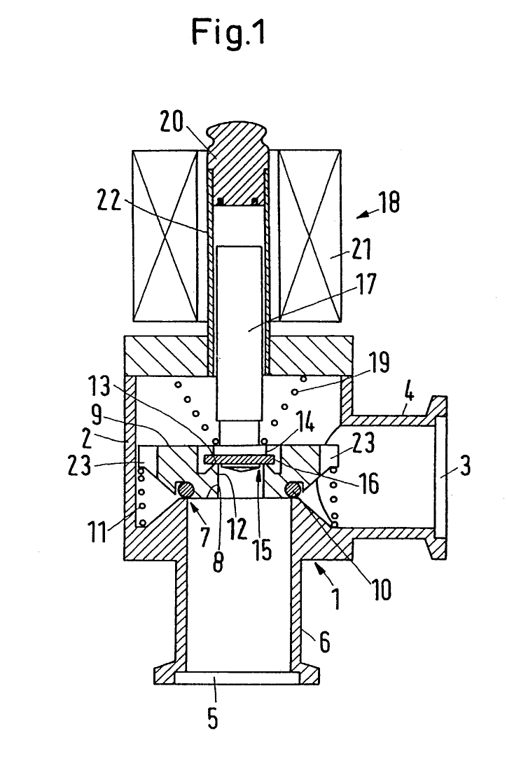

The valve arrangement illustrated in FIGS. 1-3 is used between a chamber (not illustrated) to be evacuated and a vacuum pump (not illustrated).

The valve arrangement has a housing 1 with a cylindrical housing portion 2, an input opening 3 in a connection stub 4 standing perpendicular to the housing portion 2, for the chamber to be evacuated, and a output opening 5 for the vacuum pump, in a connection stub 6 coaxial with the housing portion 2.

Formed in the housing portion 2 is a main valve 7 with a valve seat 8 and a closure member 9. The closure member 9 has a sealing ring 10, by way of which it sits onto the valve seat 8, and it is biased in the opening direction by a spring 11. The closure member 9 has a stepped bore 12 coaxial to the housing portion 2 and to the terminal stub 6, which bore with its inner shoulder forms the seat 13 for the closure member 14 of an auxiliary valve 15. The closure member 14 seats onto the valve seat 13 through a sealing ring disk 16.

The closure member 14 is formed on the end of the armature 17 of an electromagnet 18. In the turned off condition of the electromagnet 18 the closure member 14 is pressed against the valve seat 13 by a spring 19, which is stronger than the spring 11. The force of the turned on electromagnet 18 is larger than the force of the spring 18 and the additional force exerted on the closure member 15 when the valves 7 and 15 are closed and the vacuum pump is turned on. The spring 11 is so designed that in the case of the electromagnet 18 being turned on and accordingly the auxiliary valve 15 opening, the main valve 7 opens as soon as the pressure difference between the input opening 6 and the output opening 5 exceeds a predetermined relatively small value. The force to be overcome by the spring 11 is then equal to the pressure difference multiplied by the difference between the cross-sectional area A₁ of the bore of the connection stub 6 and the cross-sectional A₂ of the bore 12. The cross-sectional area A₂ of the bore 12 of the auxiliary valve 15 can be very much smaller than that of the bore of the connection stub 6. In the illustrated example the ratio A₁/A₂ of the cross-sectional surfaces lies at about 5.17. It can, however, be chosen to be larger. Thereby the predetermined value of the pressure difference and accordingly the force of the spring 11, with which the main valve 7 is opened after the auxiliary value 15 has been opened, can be chosen to be correspondingly small.

The illustrated valve arrangement has therefore the following functions and operates in the following ways:

First the vacuum pump is turned on, while the electromagnet 8 is still turned off. Both the valves 7 and 15 therefore remain closed under the vacuum pressure of the vacuum pump 9 and the force of the spring 19 so long as the electromagnet 18 remains turned off. This condition is illustrated in FIG. 1.

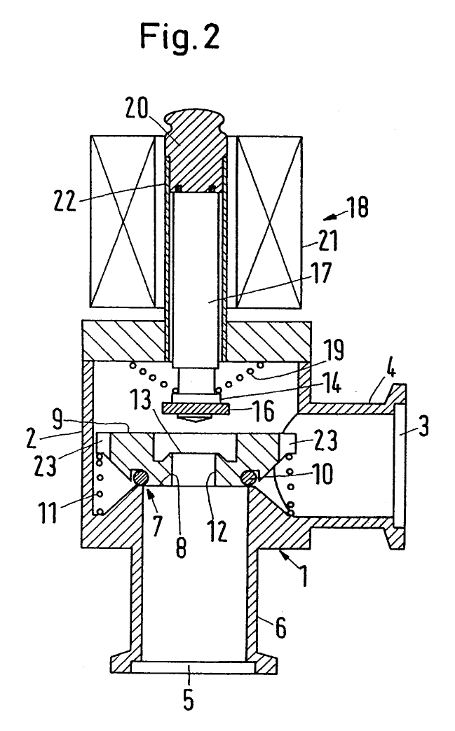

When the electromagnet 18 is turned on, the armature 17 is drawn inwardly into engagement with the core 20 in a guide sleeve 22 fastened in the coil 21 of the electromagnet and the valve member 14 is lifted from its valve seat 13 against the force of the spring 19, as illustrated in FIG. 2.

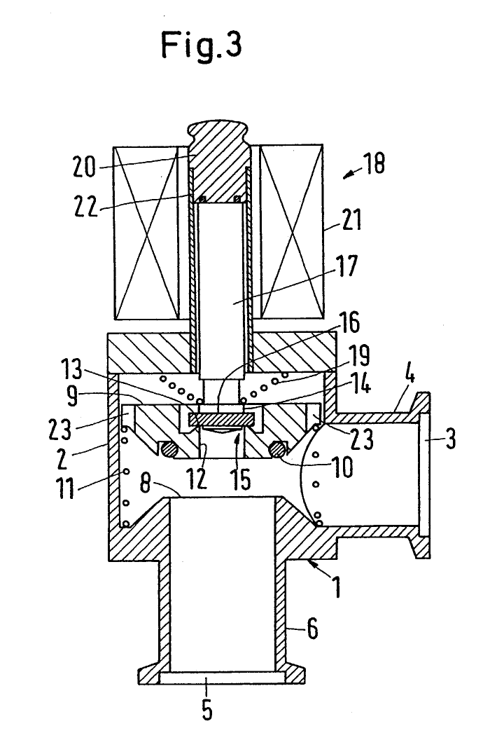

Thereupon the differential pressure between the input and output openings 3 and 5 decreases gradually because of the developing pressure equalization. The vacuum pump is therefore not overloaded by the sudden development of a mass flow or pressure impulse, since the nominal width, that is the maximum opening width, of the auxiliary valve 15 is relatively small and substantially smaller than that of the main valve 17 so that the mass flow sucked in by the vacuum pump is correspondingly throttled. When now the pressure difference at the closure member 9 falls below the predetermined value the relatively weak spring 11 opens also the main valve 7, as is illustrated in FIG. 3, so that from this point on both valves 7 and 15 are opened and the evacuation of the chamber connected to the input opening 3 and the stub 4 can progress through the fully open width of the main valve 7 substantially unhindered until the desired low pressure is reached.

Since the closure member 9 of the main valve 7 serves at the same time to form the valve seat 13 of the auxiliary valve 15, the need for a separate construction component for the formation of the valve seat 13 is avoided. Then one also avoids the need for an energy driven actuator for the main valve 7. Moreover the weak spring 11 alone is sufficient for the opening of the main valve 7, since the main valve 7 is always first opened when the auxiliary valve 15 has already been opened and a pressure difference at the closure member 17 has fallen below the predetermined small value.

At a larger circumference than that of the valve seat 8 of the main valve 7 axial through-going recesses 23 are formed in the closure member 9, in the illustrated case at the periphery of the closure member 9, the combined cross-sectional surface area of which is larger than the nominal width (the maximum opening width) of the auxiliary valve 15. This avoids that a closed hollow space remains in the housing 1 in which during evacuation can be formed between the closure member 9 and the upper region of the housing portion 12, a large air pressure which impedes the opening of the main valve 7, while the closure member 9 is moved away from the valve seat 8 by the force of the spring 11. These recesses 23 can, instead of grooves as illustrated, also be formed as axial through-going bores in the closure member 9 so as long as they are formed at a larger circumference than that of the valve seat 8 and have a larger combined cross-sectional surface area than that of the opened width of the auxiliary valve 15.

In particular only a small amount of actuating energy need be applied alone by the electromagnet 18 for the opening of the valve arrangement.

A departure from the illustrated exemplary embodiment can exist in that the spring 11 is fastened between the armature 17 and the closure member 9, so that it works as a tension spring and biasing toward the valve closing position according to FIG. 1. In particular it can be fastened at one of its ends to the closure member 14 and it can be fastened at its other end, with a correspondingly smaller sized sealing ring disk 16, to the inner shoulder of the closure member 9 radially outside of the valve seat 8.

1. A valve arrangement for use in vacuum systems, comprising a housing (1) which has an input opening (3) and output opening (5), between which is arranged a main valve (7) with a closure member (9) biased by a first spring (11) and an auxiliary valve (15) acutable by an electromagnet (18) and having a smaller nominal width than that of the main valve (7), with the closure member (9) of the main valve (7) being biased by the first spring (11) in an opening direction, the force of which first spring (11) is larger than the closing force exerted on the closure member (9) of the main valve (7) by the pressure difference between the input and output openings (3, 5,) when the auxiliary valve in an open condition.

2. A valve arrangement according to claim 1, wherein the valve seat (13) of the auxiliary valve (15) is formed by a through-going bore (12) in the closure member (9) of the main valve (7).

3. A valve arrangement according to claim 2, wherein the force of the first spring (11) is smaller than that of a second spring (19) against the force of which the auxiliary valve (15) is opened by the electromagnet (18).

4. A valve arrangement according to claim 1 wherein the housing (1) has a cylindrical housing portion (2) in which the main valve (7) is coaxially formed and the closure member (9) of the main valve (7) is guided coaxially and perpendicular to a connection stub (4) providing the input opening (3).

5. A valve arrangement according to claim 4 wherein the closure member (9) of the main valve (7) has through-going recesses (23) at a larger circumference than that of the valve seat (8) of the main valve (7).

6. A valve arrangement according to claim 5, wherein the combined cross-sectional surface area of the recesses (23) is larger than the nominal width of the auxiliary valve (15).
